(19) United States
(12) Patent Application Publication
(10) Pub. No.: US 2016/0111744 A1
(43) Pub. Date: Apr. 21, 2016

(54) REDOX FLOW BATTERY AND METHOD FOR REACTIVATION THEREOF

(71) Applicant: GILDEMEISTER energy storage GmbH, Wiener Neudorf (AT)

(72) Inventors: MARTIN HARRER, WIEN (AT); ADAM WHITEHEAD, EISENSTADT (AT)

(73) Assignee: GILDEMEISTER ENERGY STORAGE GMBH, WIENER NEUDORF (AT)

(21) Appl. No.: 14/897,454

(22) PCT Filed: May 28, 2014
(86) PCT No.: PCT/EP2014/061104

§ 371 Date: Dec. 10, 2015

(30) Foreign Application Priority Data
Jun. 13, 2013 (AT) A 50387/2013

(51) Int. Cl. H01M 8/06; H01M 8/18; H01M 8/20

(52) U.S. Cl. CPC H01M 8/0693; H01M 8/20; H01M 8/188

(57) ABSTRACT

For reactivating a redox flow battery, at least parts of the flow paths of the electrolytes of one of the half cells of the flow battery are temporarily rinsed with electrolytes of the respectively other half cell.

The invention relates to a method for reactivating a redox flow battery, wherein at least parts of the flow paths of the electrolytes of one of the half cells of the flow battery are temporarily rinsed with a reactivation liquid. Furthermore, the invention also relates to a redox flow battery for carrying out such a method, having at least one flow cell consisting of two half cells separated by means of an ion-selective membrane, as well as one electrolyte circuit per half cell, in which lines, that are optionally lockable via switching elements, connect an electrolyte tank with the half cell via a pump.

The cell resistance or stack resistance of a redox flow battery (for example a vanadium redox flow battery) may increase in a known manner over time, for example as a result of the accumulation of organic deposits on the electrodes or as a result of a deactivation of these electrodes, which results in an increase in hydrophobicity and gas retention. An occasional cleaning or reactivation of the flow battery is thus necessary, for which purpose various methods are known. It is proposed in U.S. Pat. No. 3,540,934 A to briefly overload the flow cells electrically, which does lead to the cleaning thereof, however is not conducive to the stability of the bipolar plates. A reverse polarization of the electrical connections of the cells is known from WO 12160406 A1, which nevertheless creates difficulties in the regulation of the state of charge in the cells (which are not flushed during this process), which may lead to stresses caused by overload and to the destruction of the bipolar plates. Additional, electrical circuits and control elements that withstand high currents are also required here.

It is further known from JP 3425060 B2, JP 2000200615 A2 or WO 12167542 A1 to treat the flow cells with various rinsing solutions as cleaning and reactivation liquids (for example 3M and 6M H₂SO₄ or distilled water), wherein however in all of these known cases, the reactivation liquids are kept in separate rinse tanks, which requires additional effort and thus additional cost as well as an enlargement of the entire battery. Organic rinsing or cleaning solutions are also known from JP 2004079229 A2 in the above-mentioned context, which however likewise increase the complexity of the overall system and bring additional safety risks, as most of these organic solutions are combustible.

The object of the present invention is to improve a redox flow battery and a method for its reactivation such that an occasionally necessary cleaning and reactivation can be carried out with simple means and without significantly increasing the complexity of the system.

This object is achieved by a method according to the present invention in that, for reactivation, the electrolyte of one of the half cells is used as a reactivation fluid for the respective other half cell and is passed in parallel through both half cells. For this purpose, the redox flow battery according to the invention one of the electrolyte circuits has connecting lines to at least a part of the flow paths in the other electrolyte circuit and said connection lines can be opened as needed via switching elements. The thus-possible cleaning and reactivation is very simple and requires very little additional equipment compared to the aforementioned prior art. In principle, both the use of the positive electrolyte for the cleaning and reactivation of the negative half cell as well as the use of the negative electrolyte for the cleaning and reactivation of the positive half cell is possible—both electrolytes may dissolve solid deposits from the electrodes—V₂O₅, for example, dissolves in the negative electrolyte but not in the positive electrolyte, whereas organic or metallic deposits tend to be better dissolved in the positive electrolytes. It is preferable, however, that the positive electrolyte is flushed through at least parts of the flow paths of the negative half cell, as this has been found to be more effective.

US 2006 251 957 A1 provides for a closing down of cells in a ZnBr flow battery during times in which it is not needed for the provision of energy. Here, it has previously been proposed to pump the anolyte from the anolyte tank through the catholyte electrode and back again to the anolyte tank. However, this is to prevent self-discharging during this time.

In a preferred, further embodiment of the invention it is provided that the temporarily rinsing for reactivation takes place by means of a switching of the flow paths of the respectively used electrolytes to the other half cell, wherein the electrical connection of the half cells remains unchanged. During the reactivation phase, after the same electrolyte is located in both half cells of the flow cell, the cell voltage decreases to approximately 0 volts, thus no power can be taken from the respective flow cell. The reactivation can therefore only be carried out when power is available from another source (for example for driving the pumps). However, other power sources may also be formed by other flow cells with independent electrolyte circuits or from an external voltage supply. In a battery consisting of a plurality of flow cells, only a part of the flow cells is preferably simultaneously reactivated, while the other flow cells remain in normal operation. In this way, electrical power can continue to be taken from the overall system, albeit on a level reduced by the respectively reactivated flow cells. The flow cells currently remaining in normal operation may also provide the necessary power for reactivation independent of external connections.

The reactivation may either be triggered manually by a corresponding operator or performed automatically in dependence on specific monitored cell parameters. In the case of automatic operation, automatically controlled valves with corresponding actuators may preferably be used whereby start and duration of the cleaning and reactivation may proceed according to predetermined criteria. For example, a fixed period of time from the last reactivation may be used for triggering a renewed reactivation. A reactivation can also be triggered by a change in cell resistance after exceeding a certain value. The evolution of hydrogen may also be monitored, whereby a reactivation can be initiated after a determined rise is exceeded. A monitoring of the state of charge and an introduction or execution of reactivation depending thereon would also be possible.

In a preferred embodiment of the invention, the switching elements may be formed from 3-way valves, which can be switched for the temporary cleaning of the respective half cells, which further simplifies the arrangement in the flow battery according to the invention.

The invention will be explained in more detail below with reference to schematic drawings.

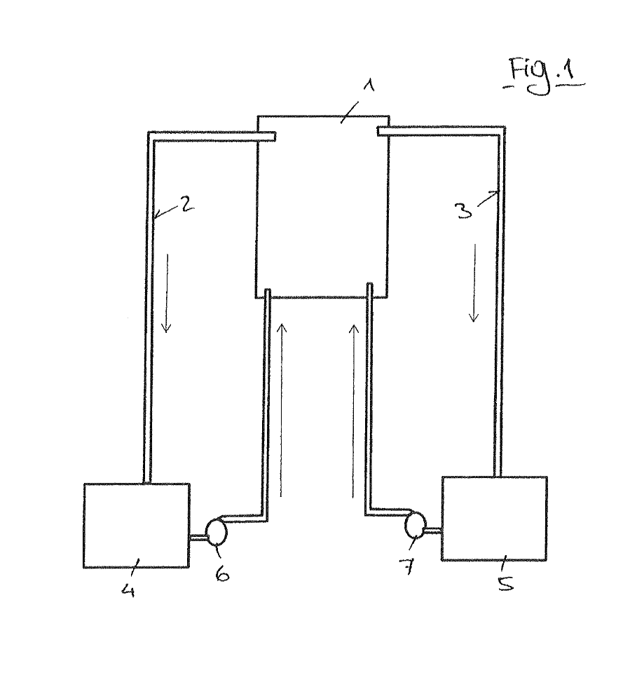

FIG. 1 shows the arrangement according to the previously known prior art, and

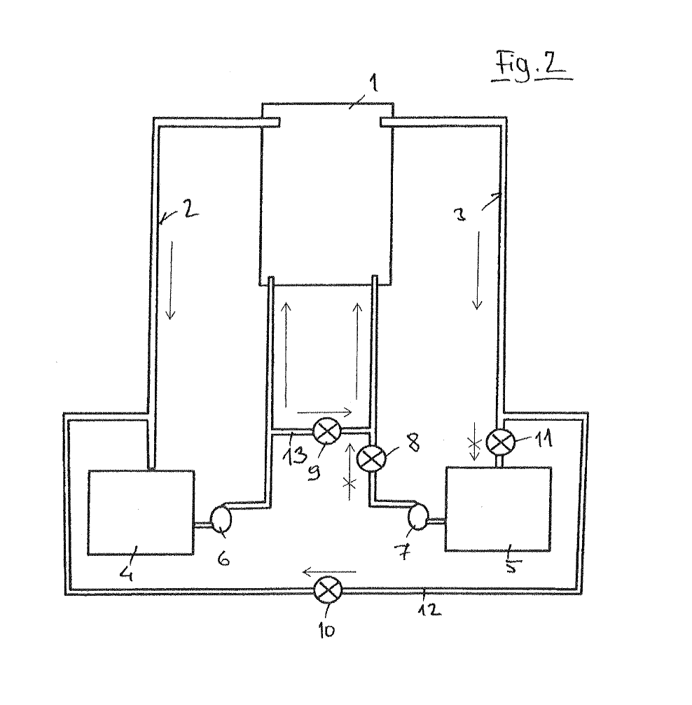

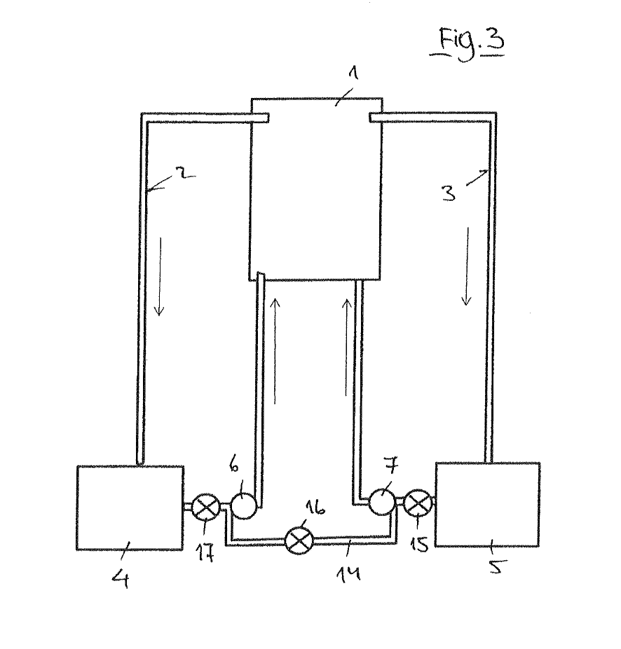

FIGS. 2 and 3 show exemplary embodiments of redox flow batteries according to the present invention.

According to FIG. 1, a stack 1 of a known redox flow battery consisting of a plurality of flow cells, not shown in detail, is connected via an electrolyte circuit 2, 3 for each of the two half cells of each flow cell, which half cells are separated by means of an ion-selective membrane, with a respective electrolyte tank 4, 5. During operation of the flow battery, positive electrolytes are circulated in one electrolyte circuit 2, 3 and negative electrolytes are circulated in another electrolyte circuit 2, 3 via a respective electrolyte pump 6, 7 and optional, additional switching elements, not shown further. As a result of the ion-selectivity of the membrane separating the two half cells of each of the flow cells, a directed charge exchange may occur between the half cells, whereby electrical power can be removed or supplied for recharging of the battery at the electrodes and electrical connections, not shown here, of the flow cells or stack 1.

Within the stack 1, the two electrolytes cannot mix freely, but are separated by the ion-selective exchange membrane on one side of the porous, typically felt-like electrodes and the bipolar plates on the other side of the electrodes. So as to be able to temporarily rinse at least a part of the flow paths in the electrolyte circuits 2, 3 of one of the half cells with reactivation liquid, which is occasionally necessary for cleaning and reactivation of the flow battery, in the arrangement according to the invention according to FIG. 2, connection lines 12, 13 to at least a part of the flow paths in the respective other electrolyte circuit are provided, which connection lines 12, 13 can be opened as needed via switching elements 8, 9, 10, 11. Assuming that reference numeral 2 is the positive electrolyte circuit and reference numeral 4 the positive electrolyte tank (correspondingly reference numeral 3 is the negative electrolyte circuit and reference numeral 5 the negative electrolyte tank), the following modes of operation exist for the arrangement according to FIG. 2:

When the switching elements 8 and 11 are open and the switching elements 10 and 13 are closed, standard operation takes place—positive electrolyte circulate in electrolyte circuit 2 and negative electrolyte circulate in electrolyte circuit 3.

When the switching elements 8 and 11 are closed and the switching elements 9 and 10 are open, positive electrolyte is pumped from the electrolyte tank 4 not only through the positive electrolyte circuit 2 but also in parallel through the electrolyte circuit 3, whereby the inventive reactivation of the flow battery occurs through the use of the positive electrolyte for both half cells of each flow cell.

When the switching elements 9 and 11 are open and the switching elements 8 and 10 are closed, the liquid levels in the two electrolyte tanks 4 and 5 can, if necessary, be re-equalized.

It is clear that within the scope of the invention other combinations of switching elements may also be used—for example, the switching elements 8 and 9 can be replaced by a single 3-way valve. The aforementioned liquid equalization (with pump delivery from the positive electrolyte tank 4 to the negative electrolyte tank 5) is suitable for stacks with cation-exchange membranes. To be able to optionally pump from the negative electrolyte tank 5 into the positive electrolyte tank, additional switching elements and/or connecting lines must be provided.

In the embodiment according to FIG. 3, negative electrolytes can be pumped from tank 5 through the positive electrolyte pump 6, which has the advantage in a vanadium redox flow battery of dissolving deposits of V₂O₅ in the positive electrolyte pump 6. The various modes of operation of the arrangement according to FIG. 3 are as follows:

When the switching elements 15 and 17 are open and the switching element 16 in the connection line 14 is closed, standard operation occurs with complete separation of the electrolyte circuits.

When the switching elements 16 and 17 are open and switching element 15 is closed, a reactivation and cleaning of the negative side occurs.

When the switching element 17 is closed and the switching elements 15 and 16 are open, a cleaning and reactivation of the positive side occurs.

When the switching elements 15, 16 and 17 are open, there occurs in turn, if necessary, an equalization of the liquid levels in the electrolyte tanks 4 and 5.

Various monitoring and control units are not shown in the drawings, with which, as needed, an automatic cleaning and reactivation may also occur. In all cases, it is provided that the cleaning and reactivation occurs solely through the various possible switchings and redirections of the present electrolytes and electrolyte circuits and thus without the complex separate supplying of reactivation liquids and without complex electrical switching at the terminals of the flow battery.

1. A method for reactivating a redox flow battery, wherein at least parts of the flow paths of the electrolytes of one of the half cells of the flow battery are temporarily rinsed with a reactivation liquid, wherein the electrolyte of the respective other half cell is used as a reactivation fluid for each half cell and is passed in parallel through both half cells.

2. The method according to claim 1, wherein the positive electrolyte is rinsed through at least parts of the flow paths of the negative half cell.

3. The method according to claim 1, wherein the temporarily rinsing takes place by means of a switching of the flow paths of the respectively used electrolyte to the other half cell, wherein the electrical connections of the half cells remains unchanged.

4. The method according to claim 1, wherein in a flow battery consisting of a plurality of flow cells, only a part of the flow cells is simultaneously reactivated, while the other flow cells remain in normal operation.

5. A redox flow battery for carrying out the method according to claim 1, having at least one flow cell consisting of two half cells separated by means of an ion-selective membrane, as well as one electrolyte circuit (2, 3) per half cell, in which lines (12-14), that are optionally lockable via switching elements (8-11, 15-17), connect an electrolyte tank (4, 5) with the half cell via a pump (6, 7), wherein one of the electrolyte circuits (2, 3) has connecting lines (12-14) to at least a part of the flow paths in the other electrolyte circuit (2, 3) which can be opened as needed via switching elements (8-11, 15-17).

6. The flow battery according to claim 5, wherein the switching elements are formed by 3-way valves, which are switchable for temporary rinsing of the respective half cell(s).
